(19) United States
(12) Patent Application Publication
(10) Pub. No.: US 2015/0170168 A1
(43) Pub. Date: Jun. 18, 2015

(54) Macro-Economic Indicator System

(71) Applicant: Bank of America Corporation, Charlotte, NC (US)

(72) Inventors: Raghuram Neela, Hyderabad (IN); Yanghong Shao, Charlotte, NC (US); Thayer S. Allison, JR., Charlotte, NC (US); David Joa, Pacifica, CA (US); Subhajit Mandal, Hyderabad (IN)

(73) Assignee: BANK OF AMERICA CORPORATION, Charlotte, NC (US)

(21) Appl. No.: 14/132,257

(22) Filed: Dec. 18, 2013

(51) Int. Cl. G06Q 30/02; G06Q 40/00

(52) U.S. Cl. CPC G06Q 30/0202; G06Q 40/12

(57) ABSTRACT

Aspects of the present disclosure are directed to methods and systems for macroeconomic indication, including electronically selectively mapping a plurality of merchant classification data to sub-sector economic data for payment card transactions classification. The method may electronically receive a plurality of retail sales data based on the payment card transactions classification over a predetermined period of time to define an economic time series dataset; electronically adjust the economic time series dataset based on an autoregressive integrated moving average; and electronically transform the economic time series dataset after the adjusting step by using linear regression to define a predefined time period percentage change in the periodic data.

### BACKGROUND

Numerous consumers use the Internet, among things to purchase products on-line, locate special events, read news stories, pay bills or perform on-line banking. Numerous business establishments are connected to the Internet to provide products and services to the consumer or perform business-to-business electronic commerce. E-commerce and Internet applications operate and transmit data over a world-wide interconnected communications network.

Retail sales estimates are provided by Federal agencies such as Census Bureau. Currently, there are known indexes that attempt to monitor the economic conditions of a region, such as the United States. For example, the Consumer Sentiment Index compiled by the University of Michigan and the Consumer Confidence Index compiled by the Conference Board attempt to indicate where the market may be headed. Both indexes are based on surveys where consumers state if they believe the economy will improve or deteriorate during the next few months. While providing a subjective measure of the economic forces, they are subjected to emotions, such as panic and/or exited exuberance. There is a need for an improved method to estimate the economic conditions of a region for a given period of time.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the present disclosure are directed to methods and systems of macro-economic indication. In one aspect, a computer implemented method includes electronically, at a computer processor, selectively mapping a plurality of merchant classification data to sub-sector economic data for payment card transactions classification; receiving, at a computer processor, retail transaction data of payment cards and demographic data for a plurality of consumers; storing the retail transaction data and demographic data for the plurality of consumers in a database, wherein each transaction data entry corresponds to a purchase by one of the consumers; electronically, at a computer processor, receiving a plurality of retail transaction data based on the payment card transactions classification over a predetermined period of time to define an economic time series dataset; electronically, at a computer processor, adjusting the economic time series dataset based on an autoregressive integrated moving average; and electronically, at a computer processor, transforming the economic time series dataset after the adjusting step by using regression to define a predefined time period percentage change in the retail transaction data.

In one aspect of the present disclosure, a computer system includes at least one database configured to maintain retail a plurality of transaction data of payment cards and demographic data for a plurality of consumers; and at least one computing device, operatively connected to the at least one database, configured to: selectively map a plurality of merchant classification data to sub-sector economic data for payment card transactions classification; selectively mapping a plurality of merchant classification data to sub-sector economic data for payment card transactions classification; receive retail transaction data of payment cards and demographic data for a plurality of consumers; storing the retail transaction data and demographic data for the plurality of consumers in a database, wherein each transaction data entry corresponds to a purchase by one of the consumers; receive the plurality of retail transaction data based on the payment card transactions classification over a predetermined period of time to define an economic time series dataset; adjust the economic time series dataset based on an autoregressive integrated moving average; and transform the economic time series dataset after the adjusting step by using regression to define a predefined time period percentage change in the retail transaction data.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments; and

FIG. 3 depicts an illustrative system in which various aspects of the present disclosure may be implemented in accordance with one or more example embodiments.

FIG. 4 depicts an illustrative operating environment in which various aspects of the present disclosure may be implemented in accordance with one or more example embodiments.

FIG. 5 depicts an illustrative operating environment in which various aspects of the present disclosure may be implemented in accordance with one or more example embodiments.

Tables 1-3 are an example mapping scheme in which various aspects of the present disclosure may be implemented in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

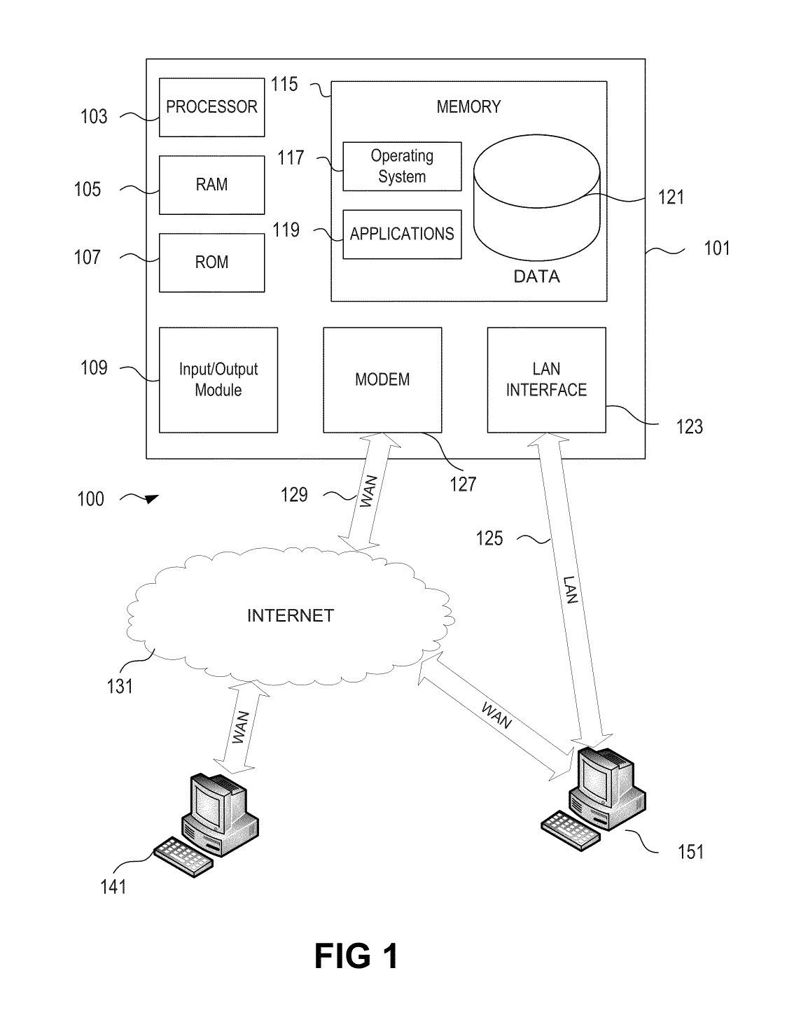

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

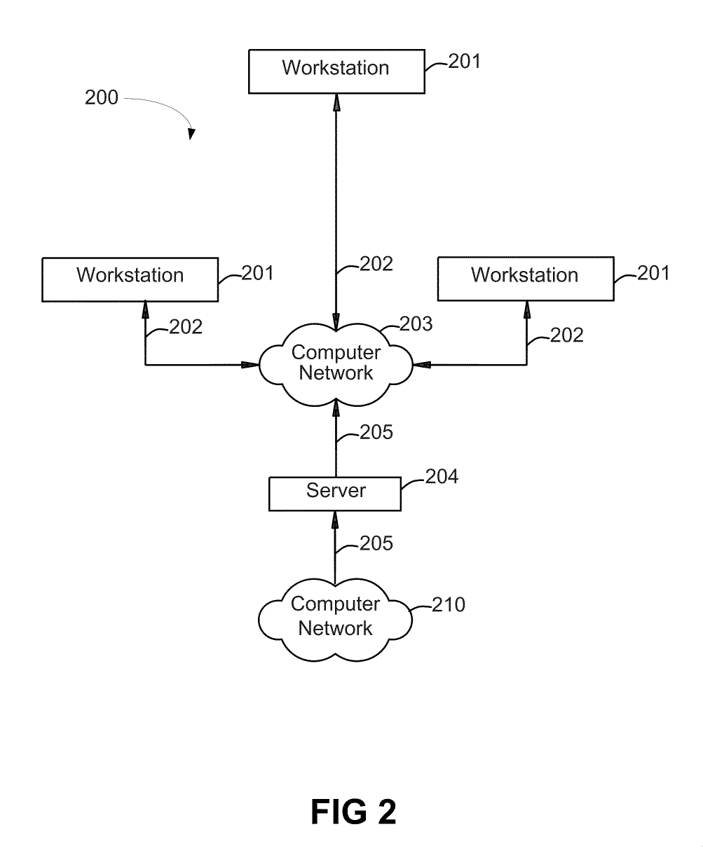

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

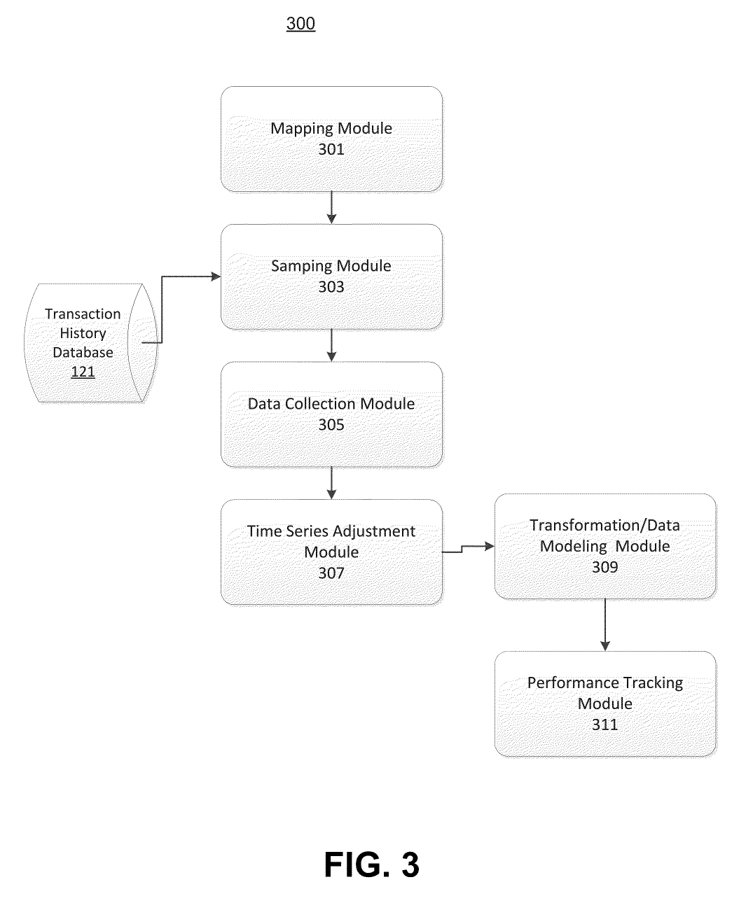

Referring to FIG. 3, aspects of the macro-economic indicator system 300 of the present disclosure may be described in the general context of computer-executable instructions, such as program modules, executed by one or more computers or other devices as described with respect to FIGS. 1 and 2. Generally, program modules include routines, programs, objects, components, data structures that perform particular tasks or implement particular abstract data types. Typically the functionality of the program modules may be combined or distributed as desired in various embodiments.

The macro-economic indicator system 300 of the present disclosure provides for a numerical estimate of the economic demand during a particular period of time for a particular geographic region. In one implementation, geographic region data may pertain to the United States economic region. The system 300 may include a computer implemented method for macroeconomic indication, including electronically selectively mapping a plurality of merchant classification data to sub-sector economic data for payment card transactions classification; electronically receiving a plurality of retail sales data based on the payment card transactions classification over a predetermined period of time to define an economic time series dataset; electronically adjusting the economic time series dataset based on an autoregressive integrated moving average; and electronically transforming the economic time series dataset after the adjusting step by using linear regression to define a predefined time period percentage change in the periodic data. System 300 includes computer program modules, executed by one or more computers as described with respect to FIGS. 1-2, such as a mapping module 301, a data collection module 303, a time series adjustment module 305, a transformation and data modeling module 307, and a performance tracking module 309.

With continued reference to FIG. 3, the system 300 may include a mapping module/component 301 which utilizes classification mapping schema. According to well-known convention, a Merchant Category Code (MCC) is a classification code that is assigned by a payment card organization to a merchant/payee. The payment cards can be debit cards and credit cards. The payment card organization assigns the merchant a particular code based on the predominant business activity of the merchant. In practice, there are more than 700 MCCs. According to a well-known convention, the North American Industry Classification System (NAICS) is the standard used by Federal statistical agencies in classifying business establishments for the purpose of collecting, analyzing, and publishing statistical data related to the U.S. business economy.

In one aspect, the mapping module 301 of system 300 can select the desired set of MCCs in the constellation of MCCs to logically map to the defined NAICS of U.S. Census Bureau economic sub-sectors. In one implementation, mapping module 301 selectively may use 109 MCCs for logic mapping to defined economic sub-sectors such as, motor vehicle and parts dealers; furniture and home furnishings stores; electronics and appliance stores; building material and garden equipment and supplies dealers; food and beverage stores; health and personal care stores; gasoline stations; clothing and clothing accessory stores; sporting goods, hobby, book, and music stores; general merchandise stores; and miscellaneous store retailers. Those skilled in the art will realize that the list of sub-sector is not exhaustive but rather an exemplary listing. Examples of an implementation of MCC mapping to a three-digit NAICS code are provided in Tables 1-3. Nevertheless, other types of mapping are possible.

With reference to FIG. 3, the system 300 may include a sampling module/component 303. Household retail sales data input may be sampled by sampling module/component 303. The server 204 may include a consumer retail transaction history database storing encrypted transactional data and demographic data for many consumers, e.g., database 121. Each transaction data entry corresponds to a purchase by one of the consumers and households. The database stores the transaction history based on the Merchant Category Code (MCC) system assigned by a payment card organization to a merchant/payee. In this way, the transaction data can be categorized for various economic sectors by the specific MCC. The transactional data may be obtained from other databases associated with a financial institution, and stores financial transaction data in such a manner that the financial transaction data can be reviewed without revealing personally identifiable information about the individual(s) with which each transaction is associated.

In one implementation, there is a mix of different types of customers in the transactional retail data in database 121. For instances, various customer purchase patterns can add volatility to the retail sales data. To better filter the data for modeling in system 300, sampling module 303 may filter consumer data points by filtering the number of credit card transactions or debit card transaction in a month. In one implementation of sampling module 303, a lower bound can be set a threshold number of transactions per month for each household. For example, one implementation of the process may use five (5) transactions per month. Nevertheless, other number transactions per month can be used for the retail sales estimation. In one implementation, the sampling component 303 has computer logic to take into account that retail payment cards might be shared within a household; as such, sample filtering can be performed over household data rather than individual customer data.

With reference to FIG. 3, the system 300 may include a data collection module/component 305. In one aspect, the data collection module 305 can collect the retail transaction data from selective transactional databases, such as database 121. In one implementation, public databases for retail sales are published with thirteen sub-sectors defined by three-digit North American Industry Classification System (NAICS) codes of the U.S. Census Bureau. These thirteen sub-sectors have several categories at further sub-levels. In the one implementation, the sub-sector level of the NAICS can be used to provide macro-economic estimates and payment card transactions can be collected for the retail sales data, while ignoring other business channels, which are mostly unused in retail sales.

With reference to FIG. 3, the system 300 may include a time series adjustment module/component 307. In one aspect, time series adjustment module 307 is provided to account for the seasonality in the historical retail sales data. This is because the customer transactions base may vary month to month, which would add extra volatility to the sub-sector time series on a month to month basis. In one implementation of time series adjustment module 307, the total spending variable is divided by the sample size for the month. In this way, the data for average household spending provides more robust statistics for modeling. In one implementation of time series adjustment module 307, the module may use the last 60 months of retail data for modeling estimation. This implementation accounts for the time series trends changing over time.

The module 307 provides for balance because too old data would be non-representative of the recent trends, while too recent data may be too short to see the trends. To account for the seasonality in data, autoregressive integrated moving average (ARIMA) techniques may be implemented in the module 307. For example, the Census Bureau's X12-ARIMA methodology could be utilized which uses a combination of linear regression outputs for the retail sales estimates. The seasonal adjustment method may input parameters for X12 pertaining to uniform input parameters for the identified sub-sectors. In one implementation of module 307, the seasonal adjustments were carried before the linear regression of the data. Nevertheless, the seasonal adjustments may be carried out after the linear regression of the data, if desired.

With reference to FIG. 3, the system 300 may include a transformation and data modeling module/component 309. In one aspect, to model the time series, level, month-over-month and year-over-year transformations can be implemented. As the month-over-month numbers provides useful input to the market analysis, month-over-month change data is suitable transformation for the independent variable in the modeling process. Additionally, linear regression techniques can implemented in the modeling process to take in account a linear relationship with the Census Bureau's month over month numbers. In the modeling process, linear regression also helps in accommodating differences in weights of economic sub-sectors within the dataset. The U.S. Census Bureau keeps on revising its estimates of retail sales over time. The estimate for the current month is called the advance estimate. When the Census Bureau calculates monthly percent changes it uses a more mature estimate of the previous month in the denominator, which is called the preliminary estimate. The transformation and data modeling module 309, assumes that most recent census bureau data is the best proxy for its revisions. In one implementation, the immediate last month Census Bureau advance estimate can used as a proxy for the preliminary estimate of the previous month which is used in the final calculations in the model estimated retail sales change. For example, one example data output would be for one month model estimate 0.1% increase in retail sales.

With reference to FIG. 3, the system 300 may include a performance tracking module/component 311 to determine how well the percentage change in the month over month retail data of the economic model matches the Census Bureau's released data. In one aspect, a performance analysis methodology can be implemented with different metrics. For example, one metric is called the average absolute error. The average absolute error formula is show below:

Average Absolute Error=Average(Absolute(Census Bureau Actual−MODEL Estimate))over Range(Base Month to Current Month)

A second metric is pertains to the direction match rate. This direction match rate pertains to the model estimate in the positive or negative direction of Census Bureau actual direction; The direction match rate formula is shown below:

Direction Match Rate=# of Direction Match with Actual/# of months

A third metric pertains to the hit rate. The hit rate measures whether the model estimate is on the correct side of consensus or not. The hit rate formula is shown below:

Hit Rate=# of times Actual and BAC Estimate were on the same side of Consensus Estimate from Bloomberg/# of months

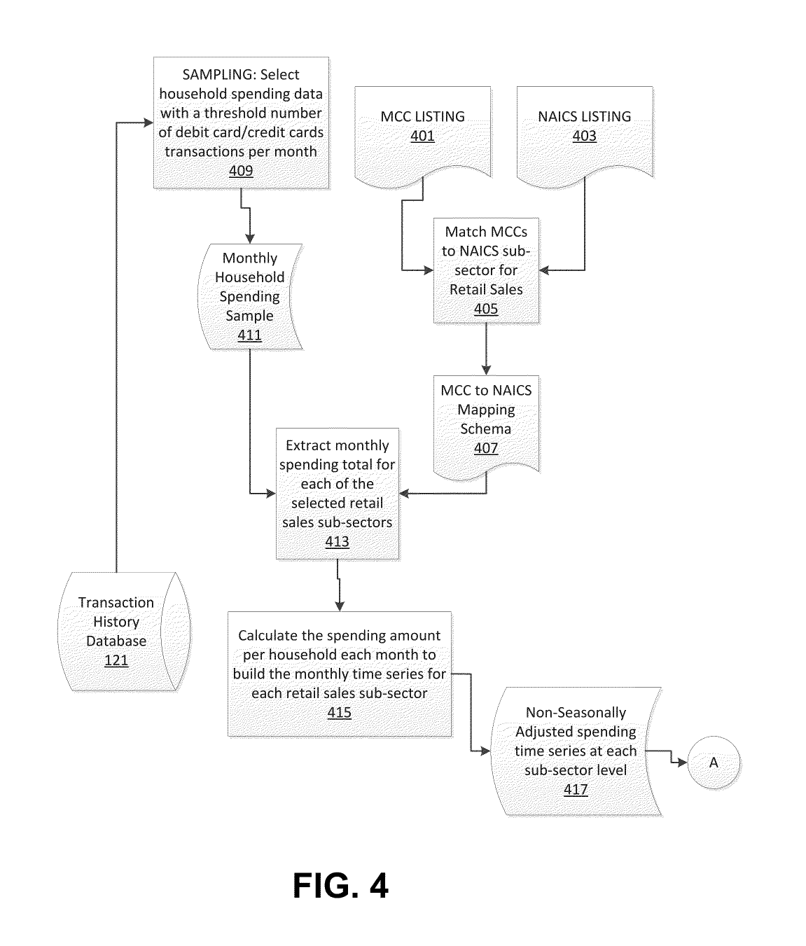

Referring to FIG. 4, in the macroeconomic indicator computer implemented process, there is a monthly data series build of retail sales transactions. In Steps 401-403, the MCC listing and NAICS listing are used for input to the monthly build of the monthly transaction dataset. In steps 405 and 407, the procedure MCC and NAICS are selected and mapped. In step 409, the process samples household transaction data with a threshold number of debit card and credit card transactions per month from a transaction history database 121. In step 411, a monthly household spending sample has various transactions based on the MCC. Then in step 413, the system extracts monthly spending totals for each of the identified retail sales sub-sectors based on data from the MCC mapping. Next, in step 415, the process calculates the spending amount per household each month to build a monthly time series for each retail sub-sector defined by the selected sub-sectors in step 405. Next in step 417, a non-seasonal adjusted household spending series at the sub-sector level (e.g., for each sub-sector) is provided for model estimation.

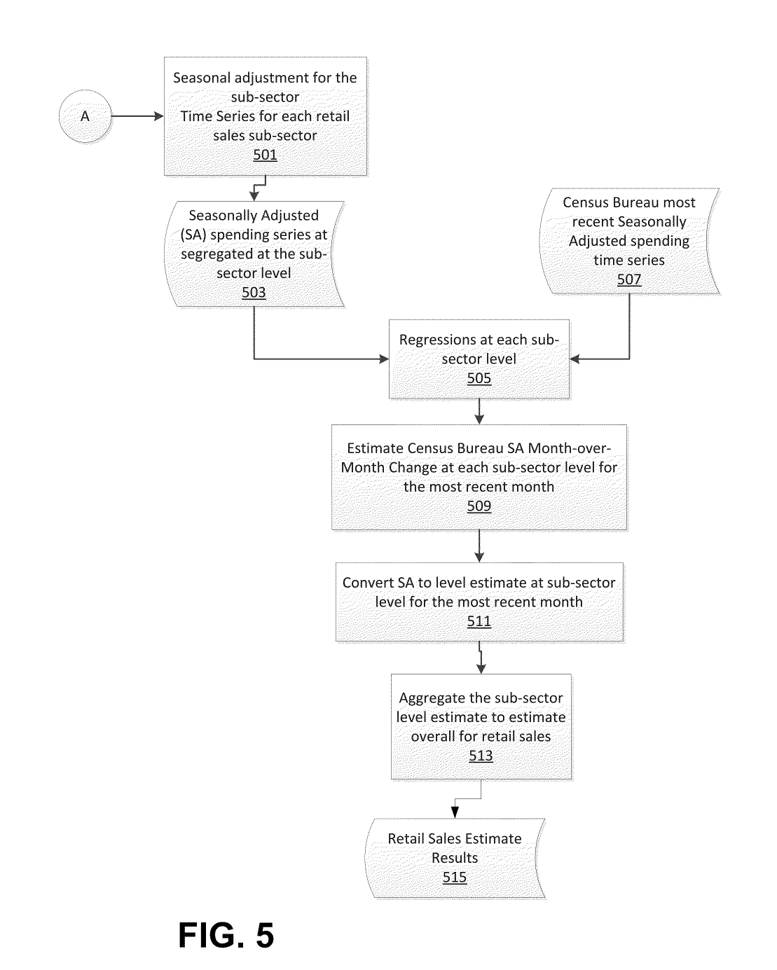

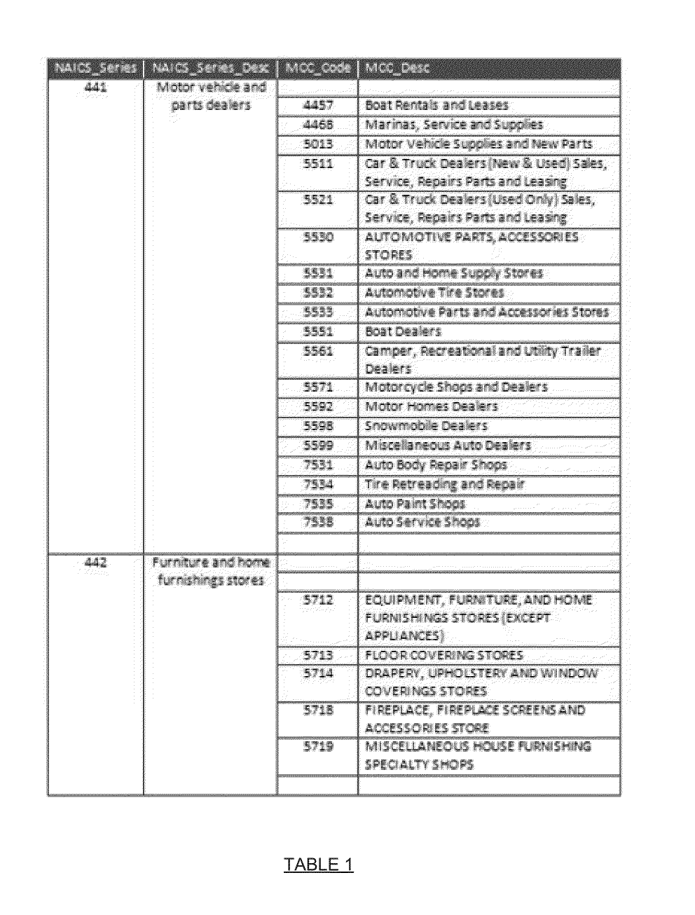

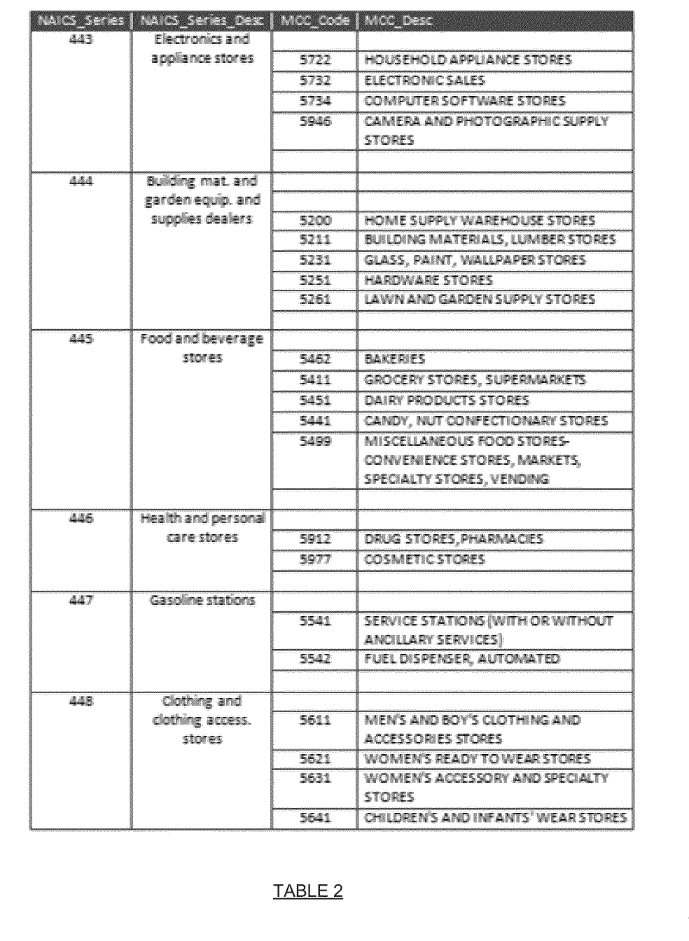

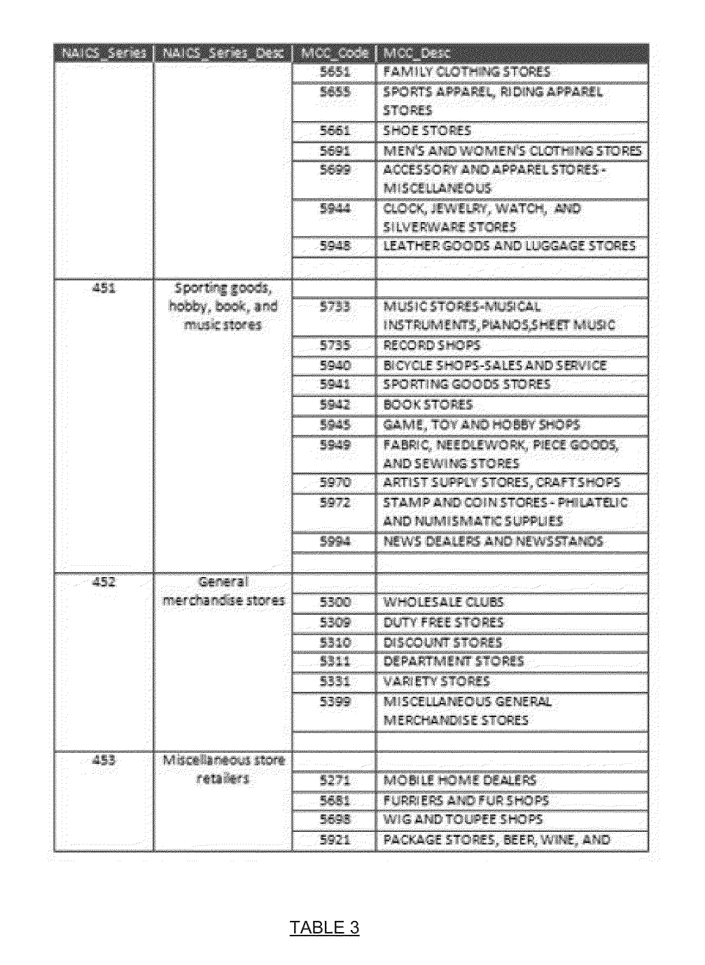

Referring to FIG. 5, the modeling process proceeds to step 501, in which the non-seasonal adjusted household spending series spending series is seasonal adjusted for the sub-sector series. The seasonal adjustment process can be implemented using autoregressive integrated moving average techniques and preferably, the X12-ARIMA process. In step 503, the seasonally adjusted spending series is provided to step 505. In step 505, the process employs linear regression at the sub-sector level using the Census Bureau most recent seasonality adjusted month-over-month as a depending variable and the seasonally adjusted month-over-month spending series data as an independent variable. In step 507, the Census Bureau most recent seasonally adjusted spending series. In step 509, the process estimates Census Bureau seasonally adjusted spending month-over-month change at each the sub-sector level for the most recent month. Next, in step 511, the model converts seasonally adjusted month-over-month estimates to a level estimate at sub-sector level for the most recent month. Next, in step 513, the model aggregates the sub-sector level estimates to estimate the overall retail sales for the geographic region (e.g., US retail sales). Finally, at step 514, the model provides the estimated retail sales and estimated the month-over-month percentage change

In yet other implementations of the system 300, cross-reference categorization mapping may be aligned to other publicly available industry classification data in the mapping component 301. For example, Bureau of Labor Statistics (BLS), financial stock markets basket indices could be used. In particular, stock baskets could be very dynamic and the composition of any particular stock fluctuates from stock market to stock market. Additionally, mutual fund indices are similarly as dynamic (for example, sector stocks—transportation, consumer, entertainment). As such, sampling module 303, data collection module 305, time series adjustment module 307, transformation and data modeling module 309, and a performance tracking module 311 could be implemented under the teaches of the present disclosure.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions for system 300 may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computer implemented method for macroeconomic indication, comprising:
electronically, at a computer processor, selectively mapping a plurality of merchant classification data to sub-sector economic data for payment card transactions classification;
receiving, at a computer processor, retail transaction data of payment cards and demographic data for a plurality of consumers; storing the retail transaction data and demographic data for the plurality of consumers in a database, wherein each transaction data entry corresponds to a purchase by one of the consumers;
electronically, at a computer processor, receiving a plurality of retail transaction data based on the payment card transactions classification over a predetermined period of time to define an economic time series dataset;
electronically, at a computer processor, adjusting the economic time series dataset based on an autoregressive integrated moving average; and
electronically, at a computer processor, transforming the economic time series dataset after the adjusting step by using regression to define a predefined time period percentage change in the retail transaction data.

2. The method according to claim 1, wherein the step of electronically adjusting the economic time series dataset based on an autoregressive integrated moving average, includes X12-ARIMA technology.

3. The method of according to claim 1, wherein the step of electronically selectively mapping a plurality of merchant classification data to sub-sector economic data for payment card transactions classification, further comprises the sub-sector defined by the North American Industry Classification System.

4. The method of according to claim 1, wherein the step of electronically selectively mapping a plurality of merchant classification data to sub-sector economic data for payment card transactions classification, further comprises the merchant classification data defined by Merchant Classification Codes.

5. The method according to claim 1, wherein the step of electronically, at a computer processor, transforming the economic time series dataset after the adjusting step by using regression to define a predefined time period percentage change in the retail transaction data, includes using linear regression.

6. The method according to claim 1, wherein the step of electronically, at a computer processor, transforming the economic time series dataset after the adjusting step by using regression to define a predefined time period percentage change in the retail transaction data, includes using an advanced retail sales estimate.

7. One or more non-transitory computer readable media storing computer executable instructions that, when executed by at least one processor, cause the at least one processor to perform a method comprising:
selectively mapping a plurality of merchant classification data to sub-sector economic data for payment card transactions classification;
receiving retail transaction data of payment cards and demographic data for a plurality of consumers; storing the retail transaction data and demographic data for the plurality of consumers in a database, wherein each transaction data entry corresponds to a purchase by one of the consumers;
receiving a plurality of retail transaction data based on the payment card transactions classification over a predetermined period of time to define an economic time series dataset;
adjusting the economic time series dataset based on an autoregressive integrated moving average; and
transforming the economic time series dataset after the adjusting step by using regression to define a predefined time period percentage change in the retail transaction data.

8. The one or more non-transitory computer readable media according to claim 7, wherein the step of electronically adjusting the economic time series dataset based on an autoregressive integrated moving average, includes X12-ARIMA technology.

9. The one or more non-transitory computer readable media according to claim 7, wherein the step of electronically selectively mapping a plurality of merchant classification data to sub-sector economic data for payment card transactions classification, further comprises the sub-sector defined by the North American Industry Classification System.

10. The one or more non-transitory computer readable media according to claim 7, wherein the step of selectively mapping a plurality of merchant classification data to sub-sector economic data for payment card transactions classification, further comprises the merchant classification data defined by Merchant Classification Codes.

11. The one or more non-transitory computer readable media according to claim 7, wherein the step of transforming the economic time series dataset after the adjusting step by using regression to define a predefined time period percentage change in the retail transaction data, includes using linear regression.

12. The one or more non-transitory computer readable media according to claim 7, wherein the step of transforming the economic time series dataset after the adjusting step by using regression to define a predefined time period percentage change in the retail transaction data, includes using an advanced retail sales estimate.

13. A computer system comprising:
at least one database configured to maintain retail a plurality of transaction data of payment cards and demographic data for a plurality of consumers; and
at least one computing device, operatively connected to the at least one database, configured to:
selectively map a plurality of merchant classification data to sub-sector economic data for payment card transactions classification;
selectively mapping a plurality of merchant classification data to sub-sector economic data for payment card transactions classification;
receive retail transaction data of payment cards and demographic data for a plurality of consumers; storing the retail transaction data and demographic data for the plurality of consumers in a database, wherein each transaction data entry corresponds to a purchase by one of the consumers;
receive the plurality of retail transaction data based on the payment card transactions classification over a predetermined period of time to define an economic time series dataset;
adjust the economic time series dataset based on an autoregressive integrated moving average; and
transform the economic time series dataset after the adjusting step by using regression to define a predefined time period percentage change in the retail transaction data.

14. The computer system according to claim 13, wherein the at least one computing device, operatively connected to the at least one database, configured to adjust the economic time series dataset based on an autoregressive integrated moving average, includes X12-ARIMA technology.

15. The computer system according to claim 13, wherein the at least one computing device, operatively connected to the at least one database, configured to selectively map a plurality of merchant classification data to sub-sector economic data for payment card transactions classification, further comprises the sub-sector defined by the North American Industry Classification System.

16. The computer system according to claim 13, wherein the at least one computing device, operatively connected to the at least one database, configured to transform the economic time series dataset after the adjusting step by using regression to define a predefined time period percentage change in the retail transaction data, includes using linear regression.

17. The computer system according to claim 13, wherein the at least one computing device, operatively connected to the at least one database, configured to transform the economic time series dataset after the adjusting step by using regression to define a predefined time period percentage change in the retail transaction data, includes using an advanced retail sales estimate.

18. The computer system according to claim 13, wherein the at least one computing device, operatively connected to the at least one database, is configured to performance track the predefined time period percentage change in the retail transaction data.
